(19) United States
(12) Patent Application Publication
(10) Pub. No.: US 2026/0257768 A1
(43) Pub. Date: Sep. 3, 2026

(54) BOAT DECK LID COVER AND METHOD OF MAKING

(71) Applicants: Russ Brenner, Navassa, NC (US); Aaron Brenner, Navassa, NC (US)

(72) Inventors: Russ Brenner, Navassa, NC (US); Aaron Brenner, Navassa, NC (US)

(21) Appl. No.: 19/466,671

(22) Filed: Feb. 2, 2026

Related U.S. Application Data
(63) Continuation-in-part of application No. 17/960,422, filed on Oct. 5, 2022, now abandoned.

(51) Int. Cl. B63B 17/02

(52) U.S. Cl. CPC B63B 17/02

(57) ABSTRACT

A device and method for being able to mount an EVA/PE (ethyl vinyl acetate and polyethylene) deck cover on a boat deck, wherein there are top and bottom layer of EVA/PE foam laminated together wherein the bottom layer is folded over the deck lid edges to a thickness which allows bending or forming of the foam edges sufficient to be bent or formed over the edges of the boat deck lid and prevent rattling. A side strip layer is also used to adjust the side thickness of the foam.

This is a continuation in part of US non-provisional application number 17/960,422 filed Oct. 5, 2022 and is included herein its entirety by reference.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a device and method for mounting an EVA/PE (ethyl vinyl acetate and polyethylene) boat deck lid cover on a boat deck.

### Description of Related Art

A boat deck is a permanent covering over a compartment or a hull of a boat (or ship), such as a bass boat. The primary or upper deck of a boat is the horizontal structure that forms the "roof" of the hull, strengthening it and serving as the primary working surface. In more than one place, there are boat deck lids on the deck that are capable of opening, which provide storage space under the deck. Marine decks can be constructed with a wide array of products including wood, fiberglass, aluminum, starboard, and the like. A primary way of covering a boat deck, such as on a bass boat, that is currently being used, is to cover it with marine grade carpeting. The carpeting is also applied on the top and sides of any boat deck lids. The side carpeting on the boat deck lids gives them a snug fit and keeps the boat deck lid from rattling as there is normally a space between the boat deck lid and the adjacent deck, which the side carpeting fills. Current EVA/PE foams are used to cover the top of boat deck lids, but this requires a different size lid to close the gaps left behind from carpet removal. This re-dimensioning of the lid may close the gap, but does not prevent rattling.

There are numerous problems associated with carpeting on the deck of a boat, even if the carpet is marine grade. These problems include, but are not limited to: mold growth; irregular wear; fading from the sun; extreme heat caused by sun exposure; unpleasant odors; difficulty cleaning; and the likelihood that the carpeting will come loose overtime, which will require repair for the safety of boating passengers.

### BRIEF SUMMARY OF THE INVENTION

The present invention relates to a new type of a boat deck lid cover, which corrects the problems disclosed above that carpeting covers and current EVA/PE covers can cause. The present invention uses a dual layer EVA/PE foam, which has been treated in such a way that the foam can be bent or formed over the sides of the boat deck lid, preventing rattling and allows for single sized boat deck lids. It further includes EVA/PE foam wrapped around the edges of the boat deck lid to seal the space between the boat deck on the sides of the boat deck lid. In some embodiments, the present invention of a boat deck lid cover allows one to rout custom patterns and designs into the top of the boat deck lid cover by use of a two-layer EVA/PE foam of contrasting colors.

Accordingly, in one embodiment, there is a covering material for a boat deck lid having sides and a top surface comprising:
a) a top layer and a bottom layer of EVA/PE foam laminated together; and
b) wherein the top layer is about the size of the boat deck lid top surface and wherein the bottom layer is bent over the sides of the boat deck lid; and
c) a side layer of EVA/PE foam on the sides of the boat deck lid such that the bottom layer and the side layer thickness prevent rattling and filling the space between a boat deck and the boat deck lid.

### BRIEF DESCRIPTION OF THE DRAWINGS

FIG. 1 is a perspective view of the top and bottom layer of the present invention.

FIG. 2 is a perspective view of the bottom of a boat deck lid.

FIG. 3 is a perspective view of the top layer 1 and bottom layer 2.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### DEFINITIONS

The terms “about” and “essentially” mean ±10 percent.

The terms "a" or "an", as used herein, are defined as one or as more than one. The term "plurality", as used herein, is defined as two or as more than two. The term "another", as used herein, is defined as at least a second or more. The terms "including" and/or "having", as used herein, are defined as comprising (i.e., open language). The term "coupled", as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

Reference throughout this document to "one embodiment", "certain embodiments", “an embodiment", or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term "or", as used herein, is to be interpreted as an inclusive or meaning any one or any combination. Therefore, "A, B, or C" means any of the following: "A; B; C; A and B; A and C; B and C; A, B, and C". An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “covering material” refers to a material designed to cover the top and sides of a boat deck lid to fill space between the edges of the boat deck lid and the boat deck using EVA/PE foam. It comprises a top layer and bottom layer laminated together. The top layer is about the size of the top of the boat deck lid, the bottom layer is larger to be bent over the edges of the boat deck lid. The sides of the boat deck lid are wrapped with a side layer of foam such that the top layer and side layer together fill the space between the boat deck lid and the deck of a boat, which prevents rattling of the boat deck lid from occurring. This 3 layer system functions like carpeting, in that it covers both the sides and top of the boat deck lid without the drawbacks of carpeting, or other covering solutions. Other solid deck coverings do not have the ability to cover the edges of the boat deck lid, requiring a different size lid depending on which material is utilized to cover the boat deck lid. The present covering material allows a boat manufacturer to produce a single sized boat deck lid. Different thickness of the side layer allows accommodation of different width spaces between the boat deck lid and the boat deck.

As used herein, the term “boat deck lid” refers to a lid which covers an open storage area on a boat deck. A hole is cut in the deck to create a storage area under the boat deck and a lid is fashioned to cover the hole with a means of opening and closing the lid. The boat deck can be any ridged material, such as wood, metal, or fiberglass, and a lid fitting the hole made with about ½ inch clearance on any non-hinged side is placed over the opening with one side being hinged to provide attachment of the lid to the deck and allow opening to the storage area. The present invention fills the space between the non-hinged edges of the boat deck lid and the boat deck.

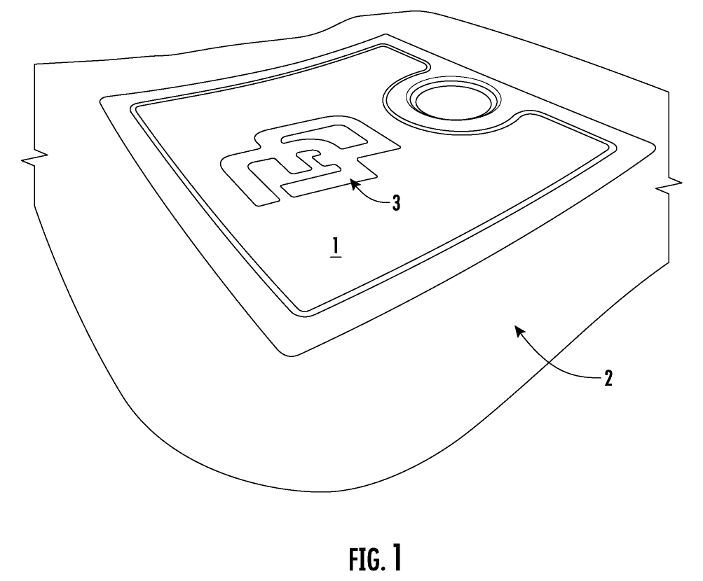

As used herein, the term “top layer and bottom layer” refers to two separate layers of EVA/PE foam being laminated together to form a single sheet. Normally, each individual layer has a thickness of from about 3mm to 6mm. In one embodiment, the two layers are of different colors so that if the top layer is removed selectively, the underlying layer color can be seen such as shown in FIG. 1. The top layer is about the size of the boat deck lid while the bottom layer is large enough to fold over the sides of the boat deck lid. The bottom layer can be slit or cut to make folding over easier and with less bulges.

As used herein, the term “EVA/PE foam” refers to an EVA/PE foam (known in one embodiment as Molylon® Foams) that is a type of chemically cross-linked closed cell foam, which mainly comprises the fundamental materials of PE (Polyethylene) and EVA (Ethylene Vinyl Acetate). In general, each layer of the foam will be a thickness of from about 3mm to about 6mm. In one embodiment, the two layers are of different colors allowing the top layer to be routed for a design of a different color from the bottom layer. The side layer of foam is of a thickness such that the bottom layer and side layer together fill the space between the non-hinged sides of the boat deck lid and the boat deck.

As used herein, the term “rattling” refers to when there is a space between non-hinged sides of the boat deck lid and the boat deck, which is great enough that the lid rattles (i.e., makes noise moving around and flexing when the boat is moving).

As used herein, the term “different colors” refers to each of the top and bottom layer of the two-ply foam being a different or contrasting color. For example, blue for the top layer and red for the bottom layer. Since the side layer is not seen, it can be any color.

As used herein, the term “a design” refers to any pattern, lettering, logo, and the like, that can be routed or laser etched in the top layer of the two-layer material to reveal the bottom layer of a different or contrasting color.

As used herein, the term “mounted” refers to the top and bottom layer foam being attached to the boat deck lid and the bottom layer being bent or formed over to cover the boat deck lid non-hinged edges. In one embodiment, the edges of the bottom layer can be cut (e.g. at the corners) to better fit the edges of the boat deck lid without overlapping. Since one edge is attached to a hinge in most embodiments, the bottom needs to only cover three sides of the boat deck lid. In some embodiments, EVA foam covers all four sides and a hinge is mounted on top.

### DRAWINGS

Now referring to the drawings, FIG. 1 is a perspective of the top layer 1 and bottom layer 2. A top layer EVA/PE foam 1 is laminated to a bottom layer EVA/PE foam 2 forming a two-layer foam. Each layer can be the same or different thicknesses and in one embodiment, the layers are different colors. The actual size of the laminated foam is as described above. In the embodiment, top layer 1 has been routed to form decorative pattern 3.

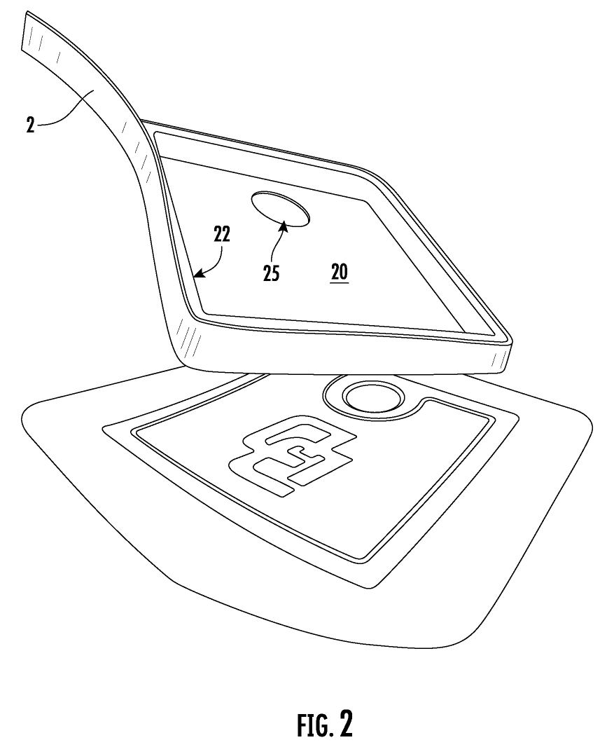

FIG. 2 is a perspective view of a bottom of a boat deck lid 20. In this view, boat deck lid 20 is being wrapped by side layer 21. The boat deck lid 20 has a thickness creating boat deck lid edges 21. The boat deck lid 20 can be hingedly opened using handle 25. In an embodiment, there is a space of about a ½ inch between the boat deck lid edge 22 and a deck 23 on the non-hinged sides of boat deck lid 20, which can cause rattling absent something on the edges of the boat deck lid 20.

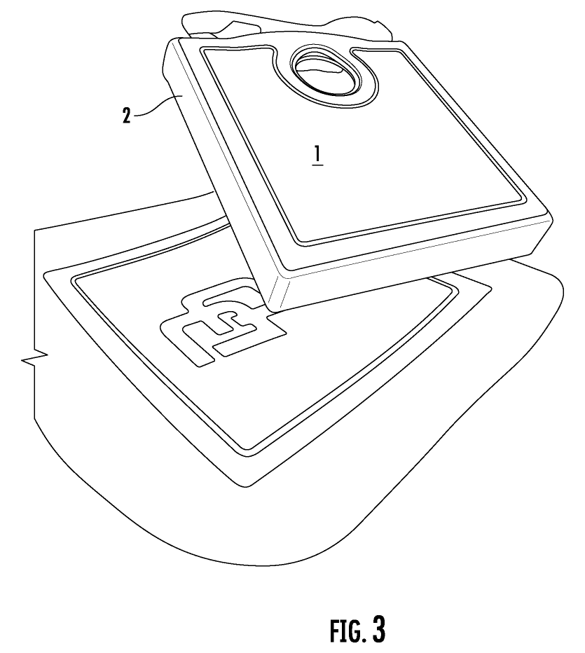

FIG. 3 is a perspective view of the top layer 1 and a bottom layer 2, wherein the bottom layer 2 is folded over the boat deck lid edges and covers the side layer.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A covering material for a boat deck lid having sides and a top surface comprising:
a) a top layer and a bottom layer of EVA/PE foam laminated together; and
b) wherein the top layer is about the size of the boat deck lid top surface and wherein the bottom layer is bent over the sides of the boat deck lid; and
c) a side layer of EVA/PE foam on the sides of the boat deck lid such that the bottom layer and the side layer thickness prevent rattling and filling the space between a boat deck and the boat deck lid.

2. The covering material for a boat deck lid according to claim 1 wherein the top and bottom layers are different colors.

3. The covering material for a boat deck lid according to claim 2 wherein a design is routed into a top layer of the two-layer foam revealing a design in the color of the bottom layer.

4. The covering material for a boat deck lid according to claim 1 wherein the two-layer foam has a thickness of from about 6mm to about 12mm.

5. The covering material for a boat deck lid according to claim 1 wherein the foam edges are routed to a thickness of between about .1 inch and about .15 inches.
